(19) United States
(12) Patent Application Publication
(10) Pub. No.: US 2023/0393728 A1
(43) Pub. Date: Dec. 7, 2023

(54) VEHICLE MONITORING SYSTEM AND METHOD

(71) Applicant: HYUNDAI MOBIS CO., LTD., Seoul (KR)

(72) Inventor: Seong Yun KIM, Yongin-si (KR)

(73) Assignee: HYUNDAI MOBIS CO., LTD., Seoul (KR)

(21) Appl. No.: 18/145,960

(22) Filed: Dec. 23, 2022

(30) Foreign Application Priority Data
Jun. 3, 2022 (KR) 10-2022-0068463

(51) Int. Cl. G06F 3/04886; G06F 3/04817; G06V 20/59

(52) U.S. Cl. CPC G06F 3/04886; G06F 3/04817; G06V 20/59; B60K 35/00

(57) ABSTRACT

The present disclosure relates to a vehicle monitoring system. The vehicle monitoring system includes a touch key control system formed of a transparent display and a touch screen, and configured to selectively display a control key corresponding to a function in a touchable manner and provide corresponding function information when a driver touches the control key, and a touch screen main monitor formed of a touch screen, and configured to display function execution information according to the corresponding function information provided from the touch key control system.

### CROSS-REFERENCE TO RELATED APPLICATIONS

This application claims the benefit under 35 USC § 119(a) of Korean Patent Application No. 10-2022-0068463, filed on Jun. 3, 2022 in the Korean Intellectual Property Office, the entire disclosure of which is incorporated herein by reference for all purposes.

### TECHNICAL FIELD

The present disclosure relates to a vehicle monitoring system and method, and more particularly, to a vehicle monitoring system capable of providing a separate control system for controlling a multimedia function, sound, wind direction function and navigation function of a vehicle.

### BACKGROUND

In general, a monitor for displaying a main function of a vehicle and a button for controlling the function of the vehicle are independently configured in the vehicle.

In the case of such a vehicle environment, there is a problem in that a driver's eyes are dispersed from a main monitor for key manipulation, and even though the driver presses a control system, there is a problem in that there is no separate feedback other than the key press operation.

In order to solve these problems, a vehicle control system function is applied to a single full touch screen.

In the case of the conventional vehicle monitoring system of manipulating a vehicle function using the full touch screen, it is necessary to enter and manipulate a menu within a display screen so as to input a command to execute a specific function, for example, air conditioner temperature, air volume control, etc. Therefore, the vehicle function manipulation is inconvenient, and there is an issue in terms of driving safety.

### SUMMARY

Various embodiments are directed to a vehicle monitoring system capable of manipulating a function control system of a vehicle without dispersing a driver's eyes from a main monitor.

Also, various embodiments are directed to a vehicle monitoring system capable of providing a driver with various types of information according to a driving environment.

Furthermore, various embodiments are directed to a vehicle monitoring system capable of independently providing the driver with main information among the information provided through the main monitor.

The objects of the present disclosure are not limited to the above-mentioned objects, and the other unmentioned objects will be clearly understood from the following description by those skilled in the art.

In an embodiment, a vehicle monitoring system includes: a touch key control system formed of a transparent display and a touch screen, and configured to selectively display a control key corresponding to a function in a touchable manner and provide corresponding function information when a driver touches the control key; and a touch screen main monitor formed of a touch screen, and configured to display function execution information according to the corresponding function information provided from the touch key control system.

The touch key control system outputs an electric equipment function control key of a vehicle on which a navigation icon, a media icon, an air conditioning icon and a sound icon of an electric equipment function are displayed, a control interface device control key on which a device home icon, a device setup icon, a device mode icon and a PWR icon are displayed, a segment information window on which information corresponding to the electric equipment function is displayed, a progress bar, an icon for each progress function, an air conditioning device icon, a resizing icon, and a media control key.

The vehicle monitoring system further comprises: a speed detection sensor configured to detect the speed of a vehicle; a sound detection sensor configured to detect in-vehicle voice; an air pollution level detection sensor configured to detect an in-vehicle air pollution level; and an electric equipment function determination unit configured to determine a necessary electric equipment function by using information detected by the sensors, wherein the touch key control system displays an electric equipment function display changed according to the electric equipment function determined by the electric equipment function determination unit.

The vehicle monitoring system further comprises: a camera configured to capture an image of the interior of a vehicle; and an operator determination unit configured to determine a person who intends to operate a center fascia from the image captured by the camera that captures the image of the interior of the vehicle, wherein the touch key control system is provided as a plurality of touch key control systems, and the plurality of touch key control systems are installed in conjunction with one another on the periphery of the touch screen main monitor, and control operations of the touch key control systems according to the determination of the operator determination unit.

The touch key control system comprises: button glass configured to provide a plurality of touch areas; and a display segment configured as a transparent display, provided above the button glass, and configured to display corresponding touch key icons in the touch areas provided by the button glass.

The touch screen main monitor and the touch key control system are laminated with a center fascia area of a vehicle, and in order to protect the laminated touch screen main monitor and touch key control system, a grinding operation is performed on an outer part of the touch key control system made of glass, and an anti-scattering film is attached to a front surface of the touch key control system.

The touch key control system further comprises a display area on which an electric equipment function icon is displayed, and a fixing unit extending from the display area and on which the electric equipment function icon is not displayed due to the absence of a circuit unit, and the fixing unit has a plurality of holes for fixing.

In an embodiment, a vehicle monitoring method includes: receiving, by a touch key control system, a touch input of an electric equipment function icon from an operator; determining, by the touch key control system, whether the electric equipment function icon is an electric equipment function which is interlocked with a touch screen main monitor; outputting, by the touch key control system, the electric equipment function when it is determined in the determining that the electric equipment function icon is the electric equipment function, which is interlocked with the touch screen main monitor, and outputting, by the interlocked touch screen main monitor, corresponding electric equipment function information; and outputting, by only the ouch key control system, the electric equipment function when it is determined in the determining that the electric equipment function icon is an electric equipment function, which is not interlocked with the touch screen main monitor.

The vehicle monitoring method further comprises determining whether an electric equipment function control event occurs, wherein when the electric equipment function control event occurs, the touch key control system outputs an electric equipment function corresponding to the corresponding electric equipment function control event.

The electric equipment function control event is one of whether a vehicle is speeding, whether an in-vehicle air pollution level exceeds a predetermined level, and whether a call service is provided.

The vehicle monitoring method further comprises detecting an electric equipment function control predictor, wherein when the electric equipment function control predictor is detected, a touch key control system at a position corresponding to the detected electric equipment function control predictor among a plurality of touch key control systems operates.

The detection of the electric equipment function control predictor includes detecting a control predictor of the touch key control system through a sound generation position.

The detection of the electric equipment function control predictor includes detecting a control predictor of the touch key control system through a camera.

In accordance with the embodiments of the present disclosure, it is possible to operate a touch screen main monitor without dispersing driver's sight, and to provide convenience for motion recognition by providing brief information about a multimedia environment currently operating in a touch key control system as well as a touch screen center fascia.

### BRIEF DESCRIPTION OF THE DRAWINGS

FIG. 1 is a reference diagram describing an installation example of a vehicle monitoring system, in accordance with an embodiment of the present disclosure.

FIG. 2 is a block diagram illustrating the vehicle monitoring system, in accordance with an embodiment of the present disclosure.

FIG. 3 is a reference diagram describing a structure of a touch key control system illustrated in FIG. 1.

FIG. 4 is a reference diagram illustrating an example of an icon display of the touch key control system illustrated in FIG. 1.

FIG. 5 is a reference diagram describing an example in which the touch key control system of FIG. 1 operates as a navigation.

FIG. 6 is a reference diagram describing an example in which the touch key control system of FIG. 1 operates as a medium.

FIG. 7 is a reference diagram describing an example in which the touch key control system of FIG. 1 operates as an air conditioning function.

FIG. 8 is a reference diagram describing an example in which the touch key control system of FIG. 1 operates as a volume function.

FIG. 9 is a reference diagram describing normal operations of the touch key control system operating as the navigation and center fascia.

FIG. 10 is a block diagram illustrating a vehicle monitoring system, in accordance with another embodiment of the present disclosure.

FIG. 11 is a reference diagram describing an operation example of the touch key control system in accordance with an embodiment of the present disclosure when a vehicle is speeding beyond specified speed in a navigation state.

FIG. 12 is a reference diagram describing an operation example of the touch key control system for providing an air conditioning function state, in accordance with an embodiment of the present disclosure.

FIG. 13 is a reference diagram describing an operation example of the touch key control system when a call is started, in accordance with an embodiment of the present disclosure.

FIG. 14 is a flowchart illustrating a vehicle monitoring method, in accordance with an embodiment of the present disclosure.

FIG. 15 is a block diagram illustrating another example of a touch key control system, in accordance with an embodiment of the present disclosure.

FIG. 16 is a reference diagram describing an example of performing a grinding operation on an outer part of the touch key control system illustrated in FIG. 3.

FIG. 17 is a reference diagram illustrating an example for describing another structure of the touch key control system.

### DETAILED DESCRIPTION

The advantages and characteristics of the present disclosure and a method for achieving the advantages and characteristics will be clearly understood through embodiments to be described below in detail with reference to the accompanying drawings. However, the present disclosure are not limited to the embodiments disclosed below, and may be embodied in various different forms. These embodiments are provided to make this disclosure thorough and complete and to fully convey the scope of the present disclosure to those skilled in the art to which the present disclosure pertains. The present disclosure is only defined by the scope of claims. Terms used in this specification are used for describing exemplary embodiments, not for limiting the present disclosure. The terms of a singular form may include plural forms unless otherwise noted. The term such as “comprise” or “comprising” used in the specification specifies a component, step, operation and/or element, but does not exclude the presence or addition of one or more other components, steps, operations and/or elements.

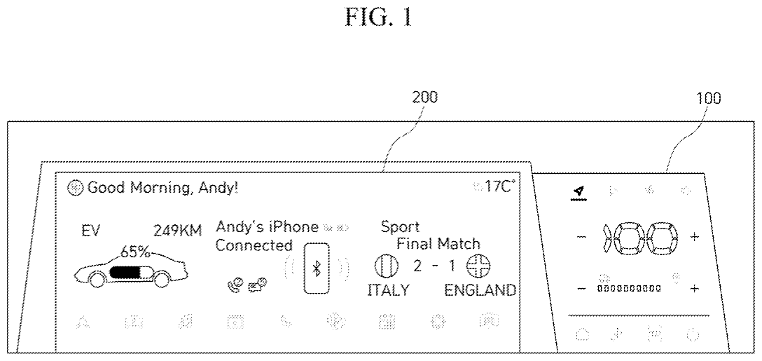

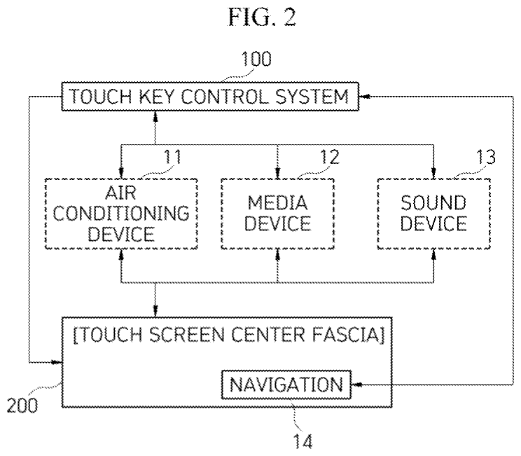

FIG. 1 is a reference diagram for describing an installation example of a vehicle monitoring system, in accordance with an embodiment of the present disclosure, and FIG. 2 is a block diagram illustrating the vehicle monitoring system, in accordance with an embodiment of the present disclosure.

As illustrated in FIGS. 1 and 2, the vehicle monitoring system in accordance with an embodiment of the present disclosure includes a touch key control system 100 and a touch screen center fascia 200.

The touch key control system 100 is formed of a transparent display and touch glass, selectively displays a control key corresponding to a function in a touchable manner, transmits a corresponding function request information to an MCU, that is, a MICOM, of a vehicle through CAN communication when a driver touches the control key, and displays information transmitted from the MCU of an electric equipment device having the corresponding function.

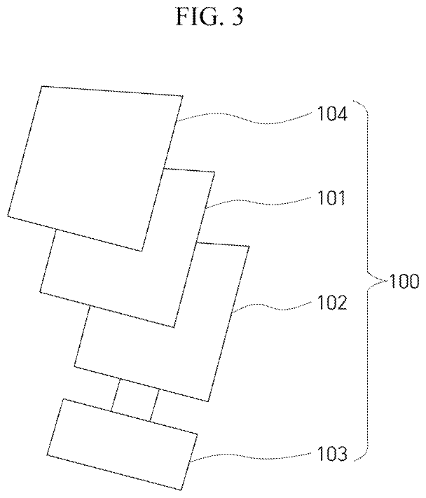

As illustrated in FIG. 3, the touch key control system 100 includes a button glass 101, a display segment 102, and a driving circuit 103. The touch key control system 100 may further include a protective transparent film 140 for protecting the display segment 102.

The button glass 101 provides a plurality of touch areas for sensing the touch of an operator.

The display segment 102, which is a segment-shaped transparent display using a light emitting organic material, is provided above the button glass 101, and displays corresponding touch key icons in the touch areas provided by the button glass 101.

The driving circuit 103 is provided to extend from one side of the button glass 101, senses the touch of the operator, and provides sensed information.

The touch key control system 100 in accordance with an embodiment of the present disclosure may be integrally installed on the right side of the touch screen center fascia 200, which is a touch screen main monitor, as illustrated in FIG. 1.

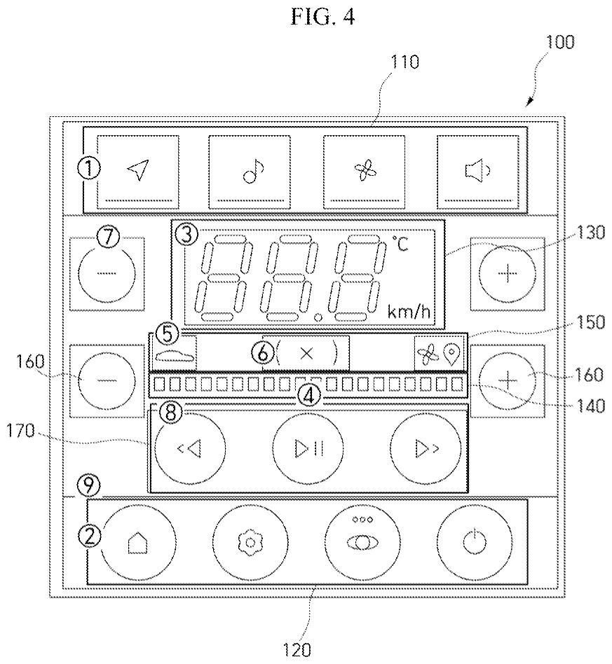

As illustrated in FIG. 4, the touch key control system 100 selectively outputs touch keys for a navigation, media, an air conditioning device CLIMATE, and volume control in a touchable manner, the touch keys corresponding to an electric equipment function of the vehicle.

In an embodiment of the present disclosure, the touch key control system 100 includes an electric equipment function control (selection) key 110 of the vehicle on which a navigation icon, a media icon, an air conditioning icon and a sound icon of the electric equipment function are displayed, a control interface device control key 120 on which a device home icon, and a device setup icon, a device mode icon and a power (PWR) icon are displayed, a segment information window 130 on which information corresponding to the electric equipment function is displayed, a progress bar 140, an icon for each progress function, an air conditioning device icon 150, a resizing icon 160, and a media control key 170.

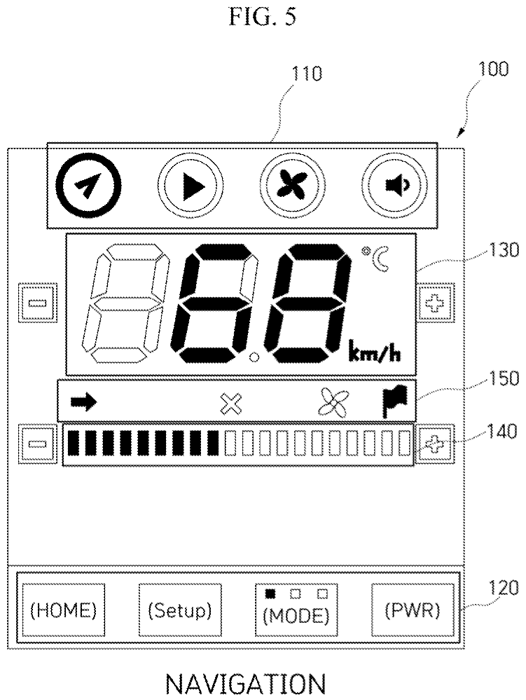

As illustrated in FIG. 5, when a navigation is selected from the vehicle electric equipment function, the touch key control system 100 displays the selection only on the navigation icon of the electric equipment function control key 110 of the vehicle, displays a speed value of the vehicle on the segment information window 130, displays the remaining distance to a destination on the progress bar 140, displays an icon according to the setting on the air conditioning device icon 150, and does not display the resizing icon 160 and the media control key 170.

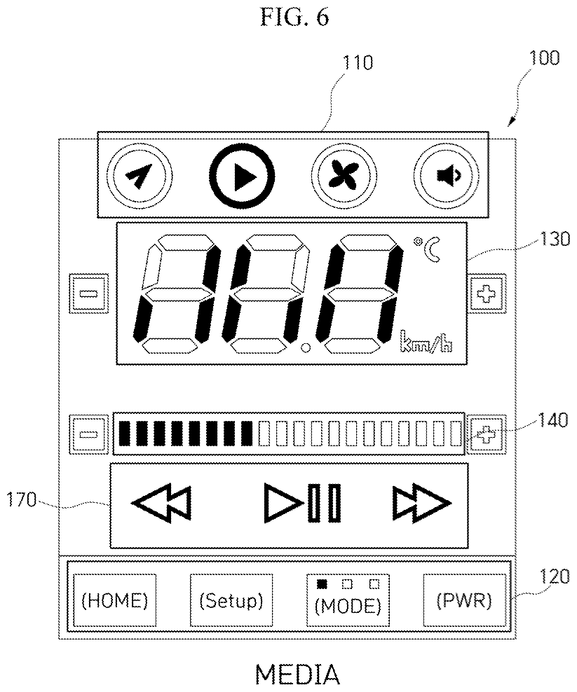

As illustrated in FIG. 6, when media is selected from the vehicle electric equipment function, the touch key control system 100 displays the selection only on the media icon of the electric equipment function control key 110 of the vehicle, displays a media information value, which is being played, on the segment information window 130, displays a media playback amount on the progress bar 140, displays the air conditioning device icon 150 and turns off the “+” and “−” icon 160, and displays the media control key 170.

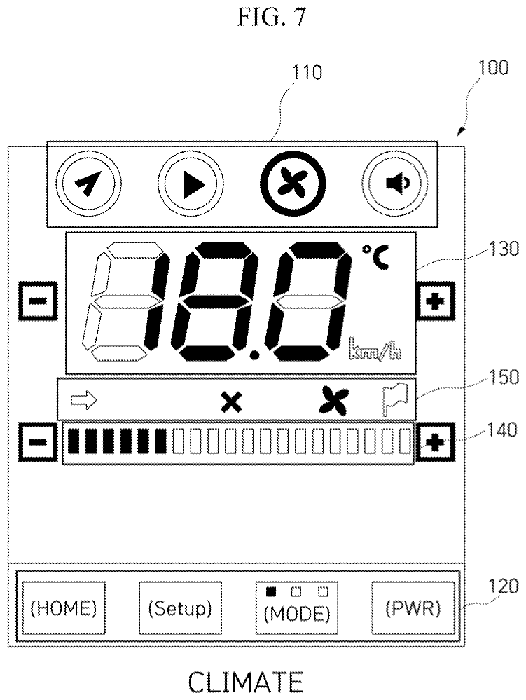

As illustrated in FIG. 7, when an air conditioning device is selected from the vehicle electric equipment function, the touch key control system 100 displays the selection only on the air conditioning device icon 150 of the electric equipment function control key 110 of the vehicle, displays an in-vehicle temperature value on the segment information window 130, displays the strength of wind and “+” and “−” for adjusting the strength of wind on the progress bar 140, displays an off icon on the air conditioning device icon 150, displays the “+” and “−” icon 160 for temperature control, and does not display the media control key 170.

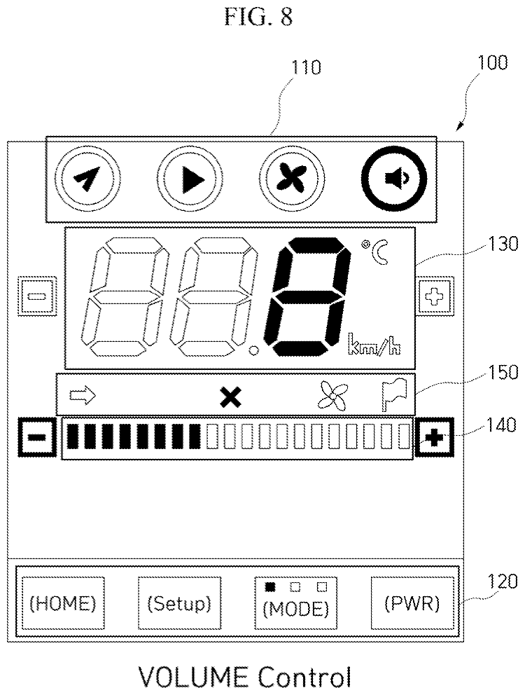

As illustrated in FIG. 8, when a sound is selected from the vehicle electric equipment function, the touch key control system 100 displays the selection only on the sound icon of the electric equipment function control key 110 of the vehicle, displays a sound volume value on the segment information window 130, displays a sound volume on the progress bar 140, displays an icon according to the setting on the air conditioning device icon 150, and does not display the “+” and “−” icon 160 and the media control key 170.

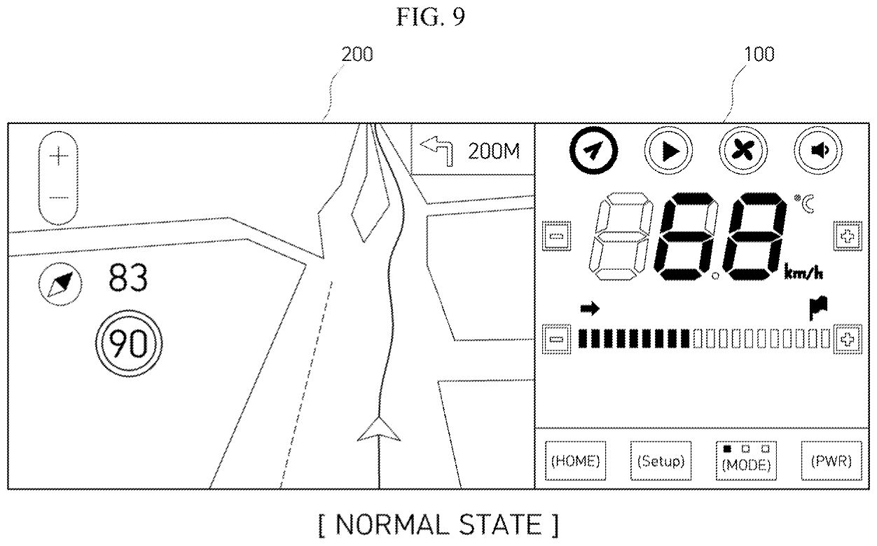

As described above, when the driver touches a control key of the touch key control system 100, function request information corresponding to the control key is transmitted to a system AP of the touch screen center fascia 200. Then, as illustrated in FIG. 9, the touch screen center fascia 200 outputs main function information according to the function request information transmitted from the touch key control system 100. In the present embodiment, when a navigation function is selected from the touch key control system 100, the touch screen center fascia 200 executes the navigation function. Then, the touch key control system 100 displays the speed of the vehicle, and displays the remaining distance to the destination on the progress bar 140.

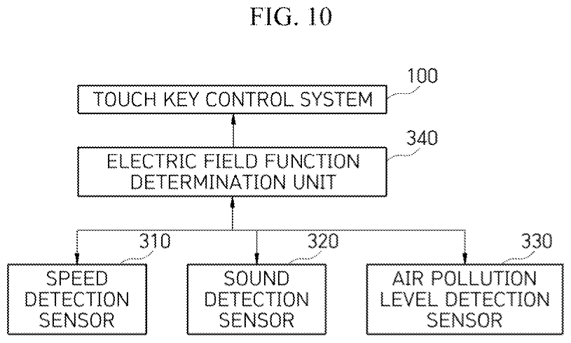

FIG. 10 is a block diagram illustrating a vehicle monitoring system, in accordance with another embodiment of the present disclosure.

As illustrated in FIG. 10, the vehicle monitoring system in accordance with another embodiment of the present disclosure may further include a speed detection sensor 310, a sound detection sensor 320, an air pollution level detection sensor 330, and an electric equipment function determination unit 340.

The speed detection sensor 310 detects the speed of a vehicle. A speed sensor may be used for the speed detection sensor 310, and a speedometer mounted on the vehicle may be used for the speed detection sensor 310.

The sound detection sensor 320 detects an in-vehicle voice. The sound detection sensor 320 may detect a direction of a person making a sound through arranged sensors.

The air pollution level detection sensor 330 detects an in-vehicle air pollution level.

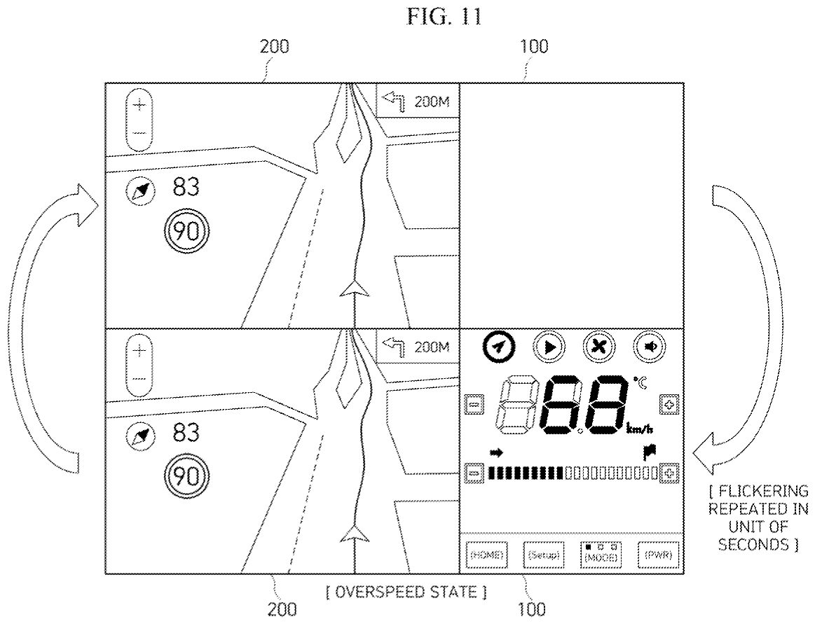

The electric equipment function determination unit 340 determines a necessary electric equipment function by using information detected by the sensors 310, 320, and 330. When the speed of the vehicle is detected by the speed detection sensor 310, the electric equipment function determination unit 340 determines whether the current speed of the vehicle is in an overspeed state. When the speed of the vehicle is in an accelerated state, as illustrated in FIG. 11, the electric equipment function determination unit 340 notifies the touch key control system 100 that the vehicle is speeding, and the touch key control system 100 indicates in various ways that the vehicle is currently speeding. In the present embodiment, the touch key control system 100 repeats flickering in a predetermined unit of seconds, but the present disclosure is not limited thereto.

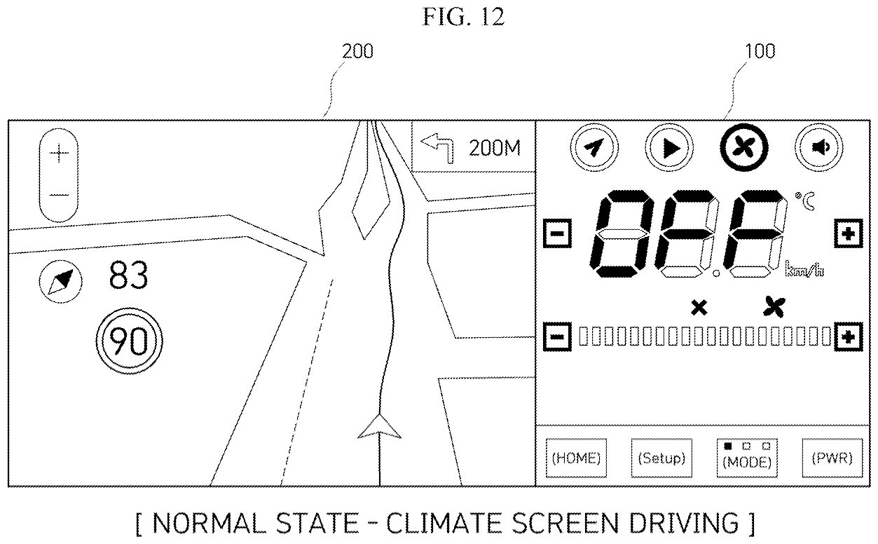

When the air pollution level detection sensor 330 detects that the in-vehicle air pollution level is equal to or greater than a predetermined value while the touch key control system 100 operates as a navigation, the electric equipment function determination unit 340 notifies the touch key control system 100 that the in-vehicle air pollution level is equal to or greater than the predetermined value, and as illustrated in FIG. 12, the touch key control system 100 changes a screen to an air conditioning function. In this case, the touch screen center fascia 200 maintains the navigation function.

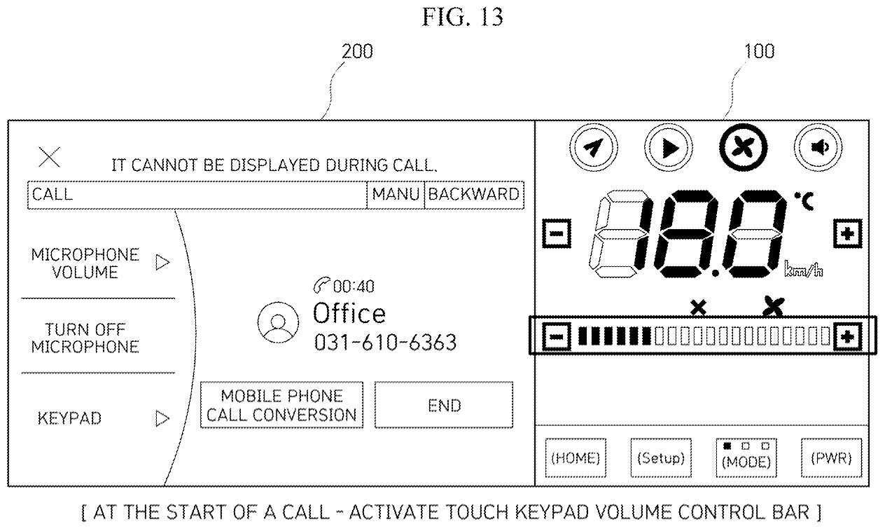

When a call is started during the driving, as illustrated in FIG. 13, the touch key control system 100 outputs a screen for adjusting the volume.

The touch key control system 100 and the touch screen center fascia 200 may be associated (i.e., interlocked) with each other or operate each independently, according to their functions.

For example, in the case of the navigation function, the touch key control system 100 and the touch screen center fascia 200 operate in conjunction with each other, and in the case of media or air conditioning device control, the touch key control system 100 and the touch screen center fascia 200 are not interlocked with each other and operate each independently.

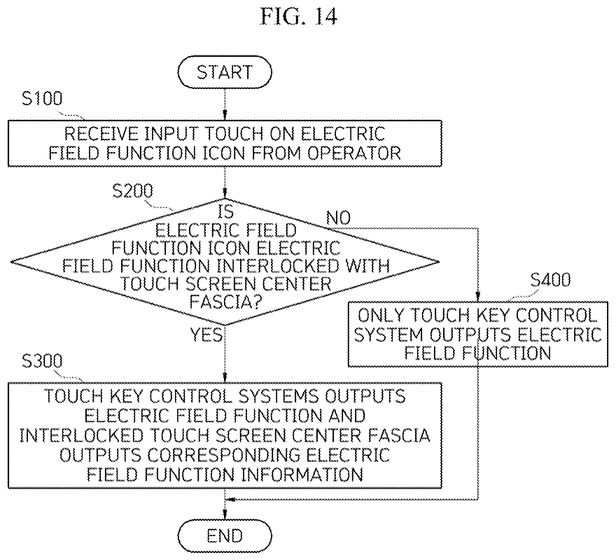

Hereinafter, a vehicle monitoring method according to an embodiment of the present disclosure is described with reference to FIG. 14.

As illustrated in FIG. 4, the touch key control system 100 selectively outputs touch keys for a navigation, media, an air conditioning device CLIMATE, and volume control in a touchable manner, the touch keys corresponding to an electric equipment function of the vehicle.

The touch key control system 100 displays an electric equipment function changed according to the electric equipment function determined by the electric equipment function determination unit.

First, when a touch on an electric equipment function icon is inputted from the operator in step S100, the touch key control system 100 determines whether the electric equipment function icon is an electric equipment function interlocked with the touch screen center fascia 200, in step S200. For example, the touch key control system 100 may be interlocked with the touch screen center fascia 200 in the case of a navigation, which is an electrical function required for driving, and operate independently from the touch screen center fascia 200 in the case of an air conditioning function and a volume function.

When the determination result of step S200 indicates that the electric equipment function icon is the electric equipment function, which is interlocked with the touch screen center fascia 200 (that is, “YES” in step S200), the touch key control system 100 outputs the electric equipment function, and the interlocked touch screen center fascia 200 outputs corresponding electric equipment function information, in step S300.

On the other hand, when the determination result of step S200 indicates that the electric equipment function icon is the electric equipment function, which is not interlocked with the touch screen center fascia 200 (that is, “NO” in step S200), only the touch key control system 100 outputs the electric equipment function in step S400.

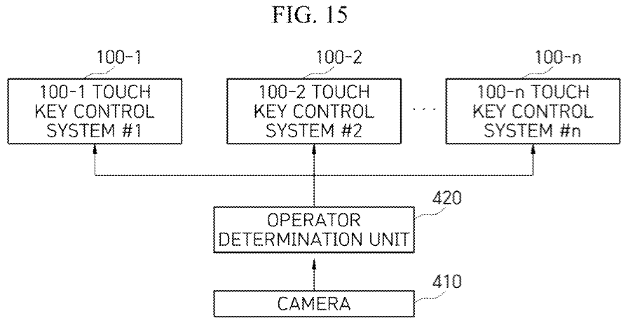

FIG. 15 is a block diagram illustrating a vehicle monitoring system, in accordance with an embodiment of the present disclosure.

As illustrated in FIG. 15, the vehicle monitoring system in accordance with the present embodiment may further include a camera 410 and an operator determination unit 420. In this case, the touch key control system 100 may be provided as a plurality of touch key control systems 100-1 to 100-n. The touch key control systems 100-1 to 100-n may be interlocked with one another to output the same information or only one representative touch key control system may operate. When the touch key control system 100 is configured as the plurality of touch key control systems 100-1 to 100-n, the touch key control systems 100-1 to 100-n may be provided on the right side of the touch screen center fascia 200, a garnish area located on a lower part in the vehicle and the left side of a driver's steering wheel.

The camera 410 captures an image of an interior of the vehicle.

The operator determination unit 420 determines a person who intends to operate the touch screen center fascia 200 from the image captured by the camera that captures the image of the interior of the vehicle.

The plurality of the touch key control systems 100-1 to 100-n are installed in conjunction with one another on the periphery of the touch screen center fascia 200, and control the operations of the touch key control systems 100-1 to 100-n according to the determination of the operator determination unit 420.

In other words, the touch key control systems 100-1 to 100-n, which are transparent touch keypads, are installed in a specific area described above, and positions at which the touch key control systems 100-1 to 100-n operate may change according to a usage aspect, e.g., manipulation of a driver, manipulation of a passenger in a front passenger seat and the like.

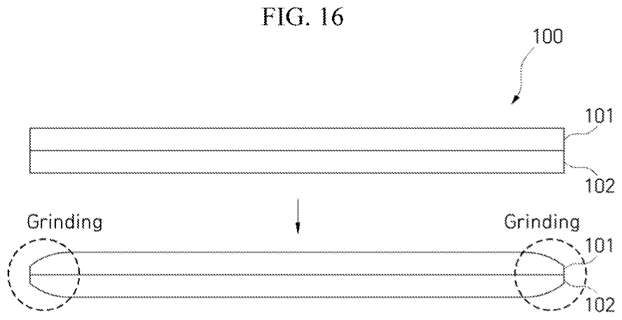

FIG. 16 is a reference diagram describing the touch key control system, in accordance with an embodiment of the present disclosure.

As illustrated in FIG. 16, a grinding operation is performed on an outer part of the touch key control system 100 in accordance with the present embodiment, which is made of glass, for securing the rigidity of the glass, after the button glass 101 and the display segment 102 are laminated, and an anti-scattering film 104 is attached to the front surface thereof. Through this operation, the touch key control system 100 may secure the rigidity of the glass. Furthermore, in order to prevent the spread of fragments when the glass is broken, the anti-scattering film 104 is applied to the front surface of the touch key control system 100 so that the spread of fragments is prevented when the glass is broken.

Since the anti-scattering film 104 has a possibility of recognizing an interface while the touch key control system 100 and the touch screen center fascia 200 are laminated, the anti-scattering film 104 may remove an interface recognition element by matching an outer circumference size of the touch key control system 100 with an outer circumference of entire monitor cover glass.

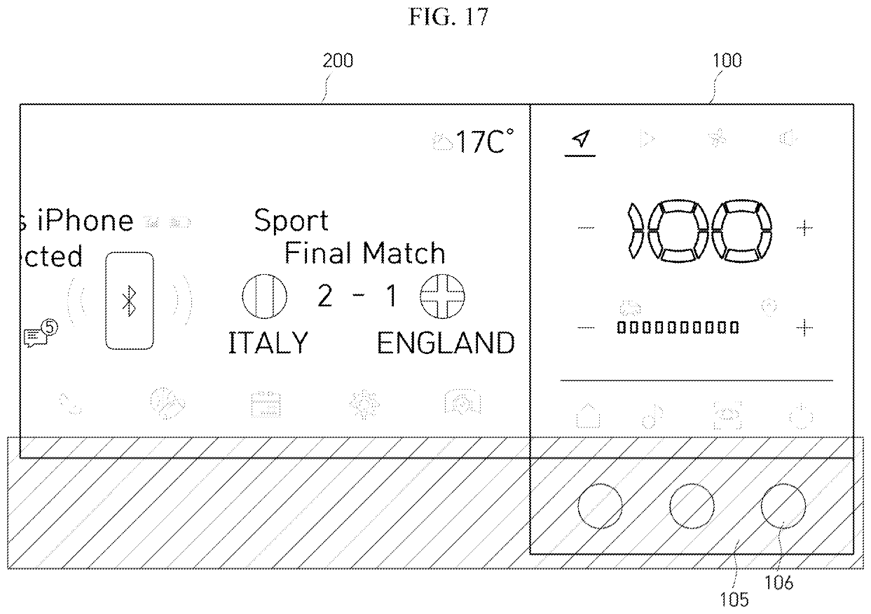

FIG. 17 is a reference diagram illustrating another example of the touch key control system, in accordance with an embodiment of the present disclosure.

As illustrated in FIG. 17, the touch key control system 100 in accordance with an embodiment of the present disclosure may further include a fixing unit 101.

Since the touch key control system 100 cannot be provided with a mechanism fixing unit on a rear surface thereof, Clearance may occur when pressure due to an actual touch is applied thereto. In order to solve this problem, the fixing unit 101 is extended from the display area, and the electric equipment function icon is not displayed on the fixing unit 101 because the fixing unit 101 does not have a circuit unit. Accordingly, the fixing unit 101 may be provided with a plurality of holes 102 for fixing.

The touch key control system 100 is laminated with the touch screen center fascia 200 located in a center fascia region of the vehicle, and the transparent protective film 140 for protecting the laminated touch screen center fascia 200 and touch key control system 100 may be further provided.

The touch screen center fascia 200 is formed of a touch screen, and displays function execution information according to corresponding function information provided from the touch key control system 100. A general center fascia may be used for the touch screen center fascia 200.

When a function key touch control signal is inputted from the touch key control system 100, an ECU (system AP) of the vehicle transmits the touch control signal to the ECU having the corresponding function, and provides the touch key control system 100 with the corresponding information.

Although the configuration of the present disclosure has been described above in detail with reference to the accompanying drawings, the description of the configuration is for illustrative purposes only, and various modifications and alternations may be made within the scope of the technical spirit of the present disclosure by those skilled in the art to which the present disclosure pertains. Accordingly, the protection scope of the present disclosure should not be limited to the above-described embodiments and should be defined by the description of the appended claims.

Each step included in the method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for monitoring a vehicle, comprising:
a touch key control system including a transparent display and a touch screen, the touch key control system configured to:
selectively display, on the transparent display, a control key corresponding to a function of the vehicle; and
in response to a driver touching a portion of the touch screen corresponding to the displayed control key, provide function information related to the corresponding function; and
a touch screen main monitor including a touch screen and configured to receive the function information and display function execution information based on the received function information.

2. The system of claim 1, wherein the touch key control system is configured to display, on the transparent display, at least one of:
an electric equipment function control key including at least one of a navigation icon, a media icon, an air conditioning icon and a sound icon of an electric equipment function;
a control interface device control key including at least one of a device home icon, a device setup icon, a device mode icon and a power icon;
a segment information window showing information corresponding to the electric equipment function,
a progress bar;
an icon for each progress function;
an air conditioning device icon;
a resizing icon; and
a media control key.

3. The system of claim 1, further comprising:
a speed detection sensor configured to detect a speed of the vehicle;
a sound detection sensor configured to detect an in-vehicle voice;
an air pollution level detection sensor configured to detect an in-vehicle air pollution level; and
an electric equipment function determination unit configured to select an electric equipment function based on information from at least one of the speed detection sensor, sound detection sensor and air pollution level detection sensor,
wherein the touch key control system is configured to display, on the transparent display, the electric equipment function electric equipment selected by the electric equipment function determination unit.

4. The system of claim 1, further comprising:
a camera configured to capture an image of an interior of the vehicle; and
an operator determination unit configured to determine, based on the captured image, a person intending to operate a center fascia of the vehicle,
wherein the touch key control system comprises a plurality of touch key control systems arranged side by side on a periphery of the touch screen main monitor and configured to control, based on the determined person, operations of the plurality of touch key control systems.

5. The system of claim 1, wherein the touch key control system comprises:
a button glass having a plurality of touch areas; and
a transparent display segment disposed above the button glass and configured to display a plurality of touch key icons at the plurality of touch areas of the button glass, respectively.

6. The system of claim 1, wherein:
the touch key control system is disposed at a center fascia area of the vehicle, and
the touch screen main monitor is laminated by the touch key control system.

7. The system of claim 6, wherein the touch key control system further comprises:
a display area configured to display an electric equipment function icon; and
a fixing unit extending from the display area and configured to fix the touch key control system to the vehicle electric equipment.

8. A method of monitoring a vehicle having a touch key control system and touch screen main monitor, the method comprising:
receiving, from an operator of the vehicle, a touch input to the touch key control system of the vehicle, the received touch input selecting an electric equipment function icon displayed on the touch key control system;
determining whether the selected electric equipment function icon corresponds to an electric equipment function associated with the touch screen main monitor;
in response to determining that the corresponding electric equipment function is associated with the touch screen main monitor, performing:
displaying, on the touch key control system, the electric equipment function electric equipment electric equipment, and
displaying, on the touch screen main monitor, electric equipment function information related to the corresponding electric equipment function; and
in response to determining that the corresponding electric equipment function is not associated with the touch screen main monitor, display, on the touch key control system, the corresponding electric equipment function electric equipment. equipment.

9. The method of claim 8, further comprising:
determining whether an electric equipment function control event occurs; and
in response to determining that the electric equipment function control event occurs, displaying, on the touch key control system, an electric equipment function corresponding to the electric equipment function control event.

10. The method of claim 9, wherein the electric equipment function control event includes at least one of:
an event that the vehicle is speeding;
an event that an in-vehicle air pollution level exceeds a predetermined level; and
an event that a call service is initiated.

11. The method of claim 8, wherein:
the touch key control system comprises a plurality of touch key control systems, and
the method further comprising:
detecting an electric equipment function control predictor; and
in response to detecting the electric equipment function control predictor, operating one of the touch key control systems positioned corresponding to the detected electric equipment function control predictor.

12. The method of claim 11, wherein detecting the electric equipment function control predictor comprises detecting, based on a sound generation position, a control predictor of the touch key control system.

13. The vehicle monitoring method of claim 11, wherein detecting the electric equipment function control predictor comprises detecting, using a camera, a control predictor of the touch key control system.
